(19) United States
(12) Patent Application Publication
(10) Pub. No.: US 2026/0022064 A1
(43) Pub. Date: Jan. 22, 2026

(54) METHOD, SYSTEM, AND COMPOSITION FOR IMPROVED CALCIUM CARBONATE CEMENT

(71) Applicant: Arelac, Inc., San Jose, CA (US)

(72) Inventors: Craig W. Hargis, Colorado Springs, CO (US); Zachary N. Haber, San Jose, CA (US); Claire L. Luethe, Mountain View, CA (US); Christopher D. Erikson, San Jose, CA (US); Ying WANG, Campbell, CA (US)

(21) Appl. No.: 19/276,730

(22) Filed: Jul. 22, 2025

Related U.S. Application Data
(60) Provisional application No. 63/674,162, filed on Jul. 22, 2024.

(51) Int. Cl. C04B 14/28; B01J 19/24; C04B 20/04

(52) U.S. Cl. CPC C04B 14/28; B01J 19/2445; C04B 20/04

(57) ABSTRACT

Various aspects relate to the production of precipitated calcium carbonate cement. Some aspects relate to a cementitious blend containing a small component having small particles and a large component calcium carbonate cement having larger particles, where the overlap between two components is engineered for achieving a tightly packed cementitious blend. In some aspects, the small component is heat-treated to reduce the surface area such that they would not displace the larger particles when blended. In some aspects, ground limestone is used in leu of, or in addition to the small component.

### CROSS-REFERENCE TO RELATED APPLICATION

This application claims the benefit of priority to U.S. Provisional Patent Application Ser. No. 63/674,162 entitled “Method, System, and Composition for Improved Calcium Carbonate Cement,” filed Jul. 22, 2024, the disclosure of which is incorporated herein in its entirety by reference.

### BACKGROUND

As the largest manufactured product in the world, cement production plays a substantial role in anthropogenic CO₂ emissions, contributing to approximately 7-8% of these emissions, as well as consuming over 3% of the global energy demand and emitting over 5% of global anthropogenic PM₁₀ emissions.

Given the ongoing global trends of population growth and urbanization, these environmental impacts are expected to persist unless mitigation strategies are implemented. In recent years, various technical measures have emerged to mitigate these impacts. For instance, the waste CO₂ from cement kilns and fossil fuel incinerators may be harnessed through processes such as carbonation curing, secondary chemical reactions for carbon capture, or geological storage. However, these measures frequently encounter technical and economic challenges when applied in cement plants, especially in developing countries where most cement products may be produced and used.

It is therefore desirable to find alternatives ways to produce low or zero carbon emission cement.

### SUMMARY

Some aspects relate to a cementitious blend including: a small component including calcium carbonate particles having a smaller size distribution; and, a large component including calcium carbonate particles having a larger size distribution; wherein the smaller size distribution and the larger size distribution have an overlap of less than a specific ratio of a total weight of the cementitious blend.

Some aspects relate to a cementitious blend, wherein the specific ratio is 30%.

Some aspects relate to a cementitious blend, wherein the small component includes calcium carbonate particles with a median size in a range of 1-11 microns.

Some aspects relate to a cementitious blend, wherein the large component includes calcium carbonate particles with a median size in a range of 10-35 microns.

Some aspects relate to a cementitious blend, wherein the cementitious blend is transformed to at least one of calcite and aragonite.

Some aspects relate to a cementitious blend, further including calcite seeds to effect a transformation of calcium carbonate particles to calcite.

Some aspects relate to a cementitious blend, wherein the small component includes 50% or less by weight of the cementitious blend.

Some aspects relate to a cementitious blend, wherein the small component is treated to reduce a surface area of calcium carbonate particles.

Some aspects relate to a cementitious blend, wherein the small component is treated by heating the small component to a temperature in a range of 150-700 degrees Celsius.

Some aspects relate to a cementitious blend including a plurality of components each including calcium carbonate particles having different sizes, wherein a size overlap of at least two of the plurality of components is less than a specific ratio of a total weight of the cementitious blend.

Some aspects relate to a cementitious blend, wherein the specific ratio is 30%.

Some aspects relate to a cementitious blend, wherein the cementitious blend includes a smaller component having calcium carbonate particles with an average size in a range of 1-11 microns.

Some aspects relate to a cementitious blend, wherein the cementitious blend includes a larger component having calcium carbonate particles with an average size in a range of 10-35 microns.

Some aspects relate to a cementitious blend, wherein at least one component having calcium carbonate particles of a smaller size is treated to reduce a surface area of the calcium carbonate particles in the at least one component.

Some aspects relate to a cementitious blend, wherein the at least one component is treated by heating the at least one component to a temperature in a range of 150-700 degrees Celsius.

Some aspects relate to a cementitious blend, wherein the cementitious blend further includes ground limestone.

Some aspects relate to a method to produce calcite cement, the method including: obtaining a first sample including calcium carbonate particles of larger size; obtaining a second sample including calcium carbonate cement including particles of smaller size; blending the first sample and the second sample to produce a tightly packed blend; and, effecting a transformation of the tightly packed blend to produce calcite cement.

Some aspects relate to a method, wherein a size distribution of the first sample and a size distribution of the second sample have an overlap that is less than a specific ratio.

Some aspects relate to a method, wherein the specific ratio is 30%.

Some aspects relate to a method, wherein the specific ratio is 20%.

Some aspects relate to a method, wherein a median size of calcium carbonate particles in the first sample is in a range of 10-35 microns.

Some aspects relate to a method, wherein a median size of calcium carbonate particles in the second sample is in a range of 1-11 microns.

Some aspects relate to a system for producing a cementitious composition, the system including: at least one reactor configured to produce a first component including calcium carbonate particles of larger size; at least one reactor configured to produce a second component including calcium carbonate particles of smaller size; and, a blending module configured to blend the first component and the second component to produce a tightly packed blend; and, at least one reactor configured to effect a transformation of the tightly packed blend to produce calcite cement.

Some aspects relate to a system, wherein a size distribution of the first component and a size distribution of the second component have an overlap that is less than a specific ratio.

Some aspects relate to a system, wherein the specific ratio is 30%.

Some aspects relate to a system, wherein the first component and the second component are produced in a common reactor.

Some aspects relate to a system, wherein the system is configured to produce different sizes of calcium carbonate cement particles by at least one of: residence time, speed at which different solutions are introduced into and extracted from a reactor, mixing speed in a reactor, and changing purity levels of a feed solution in a reactor.

Some aspects relate to a system, wherein the system is configured to treat the cementitious composition with a composition including at least one of water, calcium salt, acidic buffer, organic compound, and flow enhancement material.

Some aspects relate to a system, further including a heater configured to heat the second component to a temperature in a range of 150-700 degrees Celsius to reduce a surface area of calcium carbonate particles in the second component.

Some aspects relate to a method to produce calcium carbonate cement, the method including: obtaining a sample of calcium carbonate particles having a size distribution; and, altering the size distribution to achieve at least one of better workability and lower water demand.

Some aspects relate to a method, further using a mill to broaden the size distribution.

Some aspects relate to a method further adding a fine component to affect a setting time calcium carbonate cement.

Some aspects relate to a method, further enhancing the size distribution to lower viscosity of the calcium carbonate cement or reduces shear stiffening of the calcium carbonate cement.

Some aspects relate to a cementitious blend including: a composition including calcium carbonate particles; and, at least one additive blended with the composition to enhance a transformation of the calcium carbonate particles to calcite.

Some aspects relate to a cementitious blend, further including an acidic solution of a pH in a range of 1-7 to facilitate transformation to calcite.

Some aspects relate to a cementitious blend, wherein the pH range is optimized for protection of metal rebars from corrosion in a concrete mix.

Some aspects relate to a cementitious blend, further including an organic component to increase at least one of compressive strength and workability of the cementitious blend.

Some aspects relate to a cementitious blend, further including a calcium salt.

Some aspects relate to a cementitious blend, wherein the calcium salt is selected from a group including calcium chloride, calcium nitrate, and calcium sulfate.

Some aspects relate to a cementitious blend, further including an emulsifier to enhance flow or reduce water demand of the cementitious blend.

Some aspects relate to a cementitious blend, further including a flow aid.

Some aspects relate to a cementitious blend, further including a plasticizer.

Some aspects relate to a cementitious blend, further including a seed.

Some aspects relate to a cementitious blend, wherein the seed is selected from a group including calcite seed, aragonite seed, and crushed limestone seed.

Some aspects relate to a cementitious blend, wherein the seed includes less than 50% by weight of the cementitious blend.

Some aspects relate to a cementitious blend, further including at least one carboxylic functional group.

Some aspects relate to a cementitious blend, further including at least one of acetic acid and citric acid.

Some aspects relate to a cementitious blend, further including an air entrainer.

Some aspects relate to a cementitious blend, wherein calcium carbonate particles have at least two distinct size distributions.

Some aspects relate to a cementitious blend, wherein the at least two distinct size distributions have an overlap that is lower than a certain percentage by weight of the cementitious blend.

Some aspects relate to a cementitious blend, wherein at least a portion of calcium carbonate particles are treated to reduce a surface area of calcium carbonate particles.

### BRIEF DESCRIPTION OF THE DRAWINGS

In the accompanying figures:

FIG. 1 is an illustration of a small component vaterite particle without heat treatment.

FIG. 2 is an illustration of a small component vaterite particle after heat treatment according to various aspects.

FIG. 3 is an illustration of a large component vaterite particle.

FIG. 4 is an illustration of exemplary engineered size distribution of a calcium carbonate cement blend of small and large components according to various aspects.

FIG. 5 is an illustration of a blend of the large and small components according to various aspects.

FIGS. 6A-6D are illustrations of a process to produce a cementitious blend using heat treatment on a component of particles according to various aspects.

FIG. 7 is an illustration of a process to produce a cementitious blend using different size particle distribution and heat treatment according to various aspects.

FIG. 8 is an illustration of a process to blend different size distribution particles according to various aspects.

FIG. 9 is an illustration of a process to blend ground limestone with calcium carbonate particles according to various aspects.

FIG. 10 is an illustration of producing a cement product containing ground limestone and different calcium carbonate particle size components according to various aspects.

FIG. 11 is an illustration of industrial implementation example of various aspects using a common precipitation reactor.

FIGS. 12A-12B are illustrations of industrial implementation example of various aspects using a different precipitation reactor.

FIG. 13 is an illustration of industrial implementation example of various aspects using ground limestone.

### DETAILED DESCRIPTION

It is to be understood that the present aspects are not limited to particular aspects described, as such may, of course, vary. It is also to be understood that the terminology used herein is for the purpose of describing particular aspects only and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the present aspects. The upper and lower limits of these smaller ranges may independently be included in the smaller ranges and are also encompassed within the present aspects, subject to any specifically excluded limit in the stated range. Where the stated range includes one or both of the limits, ranges excluding either or both of those included limits are also included in the present aspects.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating unrequited number may be a number, which, in the context in which it is presented, provides the substantial equivalent of the specifically recited number.

Unless defined otherwise, all technical and scientific terms used herein have the same meaning as commonly understood by one of ordinary skill in the art to which the present aspects belong. Although any methods and materials similar or equivalent to those described herein can also be used in the practice or testing of the present aspects, representative illustrative methods and materials are described herein.

All publications, patents, and patent applications cited in this specification are incorporated herein by reference to the same extent as if each individual publication, patent, or patent application were specifically and individually indicated to be incorporated by reference. Furthermore, each cited publication, patent, or patent application is incorporated herein by reference to disclose and describe the subject matter in connection with which the publications are cited. The citation of any publication is for its disclosure prior to the filing date and should not be construed as an admission that the present aspects described herein is not entitled to antedate such publication by virtue of prior references. Further, the dates of publication provided may be different from the actual publication dates, which may need to be independently confirmed.

It is noted that, as used herein and in the appended claims, the singular forms “a”, “an”, and “the” include plural references unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

As will be apparent to those of skill in the art upon reading this disclosure, each of the individual aspects described and illustrated herein has discrete components and features which may be readily separated from or combined with the features of any of the other several aspects without departing from the scope or spirit of the present aspects. Any recited method can be carried out in the order of events recited or in any other order, which is logically possible.

Cement production is responsible for 7-8% of all anthropogenic CO₂ emissions, over 3% of global energy demand, and over 5% of global anthropogenic PM₁₀ emissions. With the megatrends of increasing global population and urbanization, these environmental impacts will not decrease if mitigation applications are not adopted. In recent years, various technical measures were found to alleviate these impacts. For example, the CO₂ in the waste gas from the cement kiln and fossil fuels incinerator can be collected for carbonation curing, secondary chemical reactions for carbon capture, geological storage, etc. But these measures often have technical and economic challenges for application in cement plants.

Vaterite, aragonite, and calcite cements may be produced by using re-absorption and precipitation of CO₂ from a cement kiln or from other industrial sources. These different polymorphs may be cementitious on their own when mixed with water, and they can also be used as a supplementary material for blended cements.

Vaterite is the least stable and more soluble polymorph and rarely exists in nature, whereas aragonite and calcite are the more stable and common crystalline polymorphs. Calcite, in particular, is the most stable of the three polymorphs.

Calcite constitutes the primary mineral phase in limestone, alongside the less common anhydrous polymorphs of calcium carbonate, aragonite, and vaterite. Vaterite, albeit less stable and more soluble, may be generated from CO₂ generated at cement kilns.

Various aspects may be implemented in existing plants such as cement or concrete plants. Portland clinker is manufactured through mining a variety of mineral such as calcia, silica, alumina, and iron oxide sources, such as limestone, clay, and shale.

These materials are then crushed, ground, and proportioned to make a feed for a kiln. In the kiln, the feed is traditionally heated typically to 1450° C. and forms Portland clinker. Different cementitious composition may be produced according to various aspects.

Production of calcium compound by calcining limestone may be carried out using various types of kilns, such as, but not limited to, a shaft kiln, a rotary kiln, an electric kiln etc. These apparatuses for calcining are suitable for calcining limestone in the form of lumps having diameters of several to tens millimeters.

Cement plant waste streams include waste streams from both wet process and dry process plants, which may employ shaft kilns or rotary kilns, and may include pre-calciners. These industrial plants may each burn a single fuel, or may burn two or more fuels sequentially or simultaneously.

Traditionally, limestone obtained from a limestone quarry is subjected to calcination in a cement plant resulting in the formation of calcium compounds such as calcium oxide, calcium hydroxide, or combination thereof, and CO₂ gas.

The calcium compound may be calcium oxide in the form of a solid from dry kilns or cement processes or may be a combination of calcium oxide and calcium hydroxide in the form of slurry in wet kilns or cement processes.

When wet, the calcium oxide (also known as a base anhydride that converts to its hydroxide form in water) may be present in its hydrated form such as calcium hydroxide. While calcium hydroxide (also called slaked lime) is a common hydrated form of calcium oxide, other intermediate hydrated and/or water complexes may also be present in the slurry, and they are all included within the scope of the present aspects.

In various aspects, calcium carbonate cement manufacturing process may utilize any of many types of limestone with various impurities. High calcium or high purity limestones may be utilized to make lime and calcium carbonate cement such as vaterite, aragonite, and calcite, which in turn have high purity.

Limestones that contain impurities can be first made into lime. Then the lime may be brought into the ReCarb™ process where it is solubilized in the process solution (ReCarb™ is a trademark of Fortera Inc.). The insoluble lime impurities may then be removed from the process solution via filtration. During the calcination of magnesium bearing limestones, such as magnesian limestone, dolomitic limestone, or dolomite, magnesium oxide is formed and can be separated from the process solution. Silica rich lime deriving from the calcination of silica rich limestones, such as sandy limestone, cherty limestone, or siliceous limestone, may have the lime solubilized in the ReCarb™ process and the silica impurities filtered off. Alternatively, the impurities could be finely divided by milling or grinding and then allowed to pass through the ReCarb™ process unchanged.

Clay bearing limestones, such as argillaceous limestone or marl, may provide additional benefits to ReAct™ blend. During the calcination of the clay bearing limestone, the clay loses water, making it more easily dissolve and become more reactive in hydraulic cements systems. In other words, the clay fraction becomes more pozzolanic. Consequently, clay bearing limestones can be used to make ReAct™ Blend that contains both a carbonate and pozzolanic component.

Conventional methods for optimizing particle packing in cement, attempt to enhance the packing by increasing the width of particle distributions without surface area considerations, and as such, they may on the contrary, result in increased water demand despite attempting to improve particle distributions.

In conventional ordinary Portland cement, water is chemically used up as the material reacts with water. However, in calcium carbonate cements, different polymorphs make the dynamics different. For instance, when vaterite converts to aragonite and/or calcite, water is not permanently chemically bound or used. As a result, all the water added into the cementitious product may turn into porosity in the final cementitious material. This, in turn, affects the compressive strength of the final cementitious product.

Since pores are empty pockets that cannot carry load, higher porosity materials are generally weaker in terms of compressive strength. As such, compared to conventional Portland cement, it is especially important to reduce the water input into the calcium carbonate cement and thereby to reduce the resulting porosity.

Various aspects enable reductions in the water demand by engineering mixtures of different sized particles and different surface area, and thereby effectively reducing the water demand, and increasing the compressive strength of calcium carbonate cement.

Typically, different particle sizes in calcium carbonate cement have different surface area attributes, quantified by surface areas. Generally, smaller size particles have greater surface areas and larger size particles have smaller surface areas measured in the units of m²/g indicating square meters per gram of mass. The surface area measured by BET is comprised of both external surface area and surface area that is inside the volume of the particles.

In various aspects, the surface areas for the various particle sizes are given in m²/g. This unit represents an estimate of the total surface area of the particle relative to its total mass. In various aspects, in order to achieve a reduced water demand, such particles are heat-treated, resulting in smoother surfaces and therefore lower surface areas.

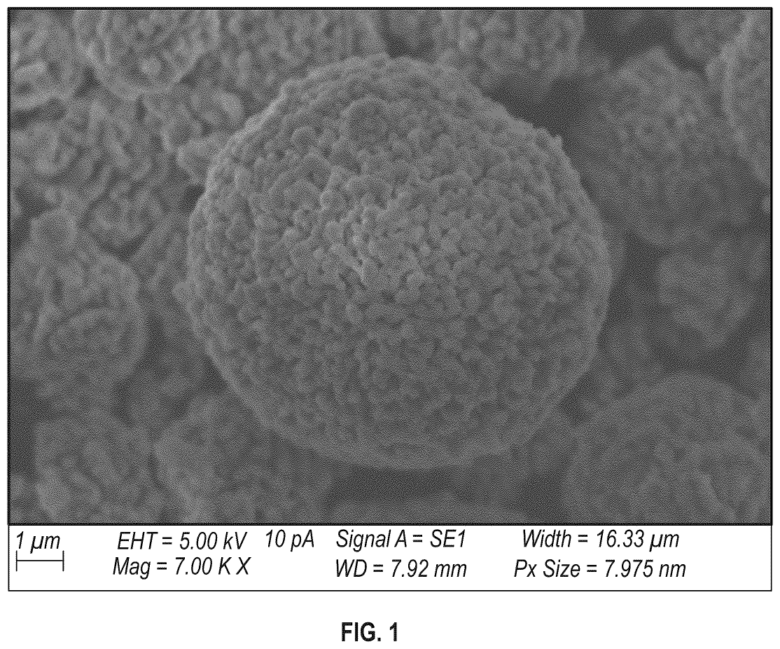

FIG. 1 is an illustration of a small component vaterite particle without heat treatment. The scale of the figure is 1 micron shown by the scale indicator at the bottom left of the figure. The vaterite particle is more or less spherical. The larger surface area ratio of the vaterite particle in FIG. 1 stems partially from the structure of the crystals. This structure is seen on the surface of the figure, however, the same or similar structure runs through the volume of the particle.

At least a portion of the small component calcium carbonate particles may transform from the vaterite polymorph to the calcite polymorph during the heat treatment process. This heat treatment process may involve a solid-state transformation from the vaterite polymorph to the calcite polymorph. During this transformation, the macroscopic structure of the calcium carbonate particles may be more or less preserved, but the microscopic surface topography is smoothened, resulting in a lower surface area. Through this process, calcite of a general spherical shape may be produced. The shape of the calcite produced in this fashion is in marked contrast to either naturally produced limestone, or calcite produced via wet synthesis, which would be rhombohedral in shape. Through this heat treatment process, the surface area is reduced, and a better packing structure is maintained.

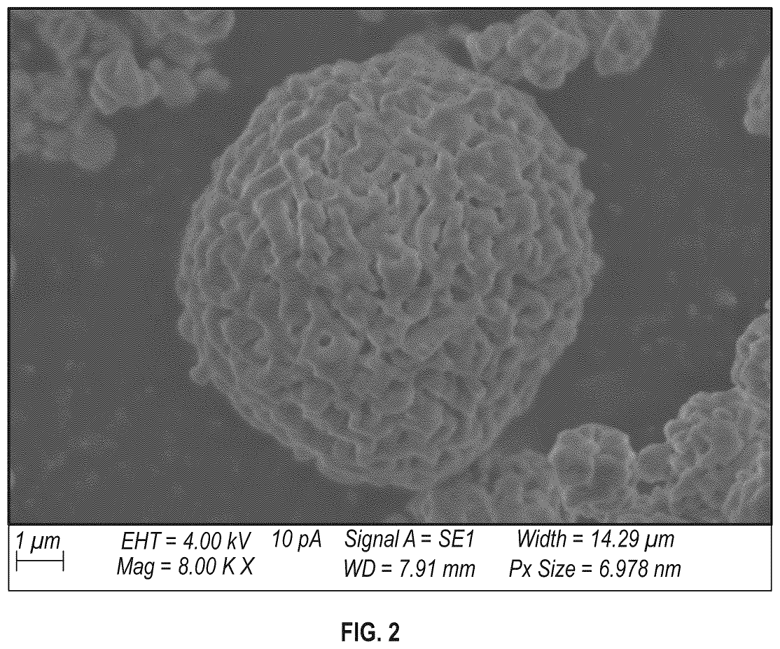

FIG. 2 is an illustration of a small component vaterite particle after heat treatment according to various aspects. The scale of this figure is also 1 micron shown by the scale indicator at the bottom left of the figure and it is also more or less spherical. The smaller surface area ratio of the heat-treated vaterite particle in FIG. 2 appears to have a less grainy structure compared to FIG. 1. The smoother texture on the surface of the crystal runs through the volume of the sphere, and as a result, this heat-treated vaterite particle has a smaller surface area. The diameter of the particle in both FIG. 1 and FIG. 2 is about 6 microns.

According to various aspects, the transformation of vaterite to calcite causes the formation of micro-cubic like structure. These structures may be seen on the surface of the particle shown in FIG. 2, but they do occur throughout the volume of the particles even though the overall spherical shape is preserved. This feature may be an advantage in some applications as the spherical shape is preserved even though the vaterite has transformed to calcite.

In some aspects, heating the cementitious composition to a temperature of up to 90° C. may speed up the transformation of vaterite or other polymorphs, such as aragonite, to calcite.

According to various aspects, when calcium carbonate particles are heated, a crystallographic rearrangement may occur in which the crystal lattices achieve a lower energy state. This typically results in the surface of the material being smoothened resulting in a decreased surface area. This may be done so that the unit cells are preserved and a polymorph such as vaterite remains as the same polymorph.

In various aspects, at a larger scale the heating may cause converting from one polymorph of calcium carbonate to another, such as from vaterite or aragonite to calcite. Typically heat treatments that see a conversion from one polymorph to another result in a larger reduction to surface area compared to those where the original polymorph is preserved. Heat treating vaterite by raising the temperature in the range of 150-700° C. or a range of 300-600° C. can result in surface area reductions of 0 to >70%. By reducing the surface area of these particles, reaction kinetics & water demand can be controlled for optimal material performance.

In some aspects, in addition to or in leu of heat treatment, processing at least a portion of calcium carbonate particles may include adjusting a concentration of at least one of a calcium oxide and ammonium chloride added to the cementitious composition.

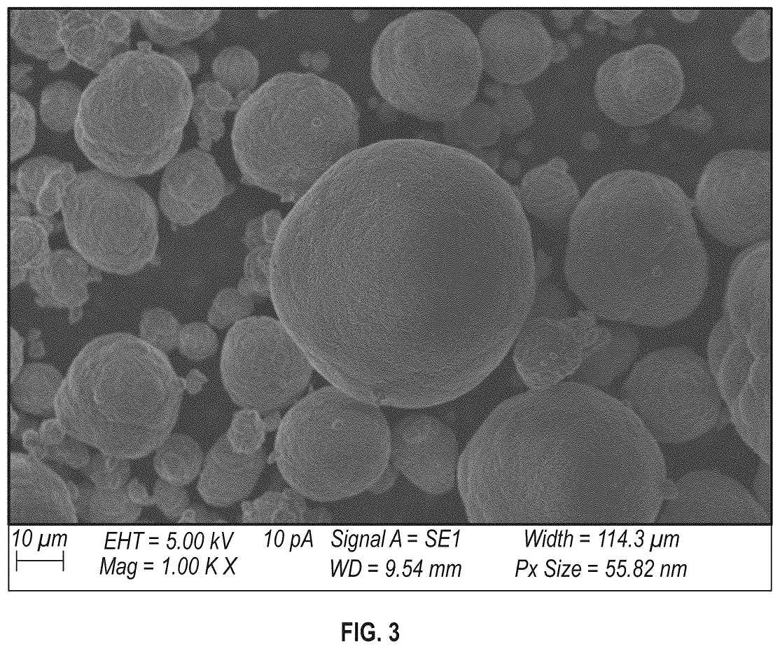

FIG. 3 is an illustration of a large component vaterite particle. The scale of the figure is larger than the previous figures, at 10 microns shown by the scale indicator at the bottom left of the figure. This large component vaterite particle is also more or less spherical. The smaller surface area of the vaterite particle in FIG. 3 is due to its larger size.

To provide some quantification of the surface area used in various aspects, a few examples are hereby provided. For instance, a small component, which represents one component of a cementitious blend consisting of vaterite particles, may have a surface area in the range of 3-7 m²/g.

Meanwhile, a heat-treated small component may include vaterite particles which are heated and transformed to calcite, having surface area of 1-4 m²/g.

Various aspects may utilize a small component containing ground limestone, at least partially, with a surface area of 1-5 m²/g. The ground limestone may be used by itself or may be blended with small-sized or large-sized vaterite, aragonite, or calcite particles to form the small or large component in different aspects as will be described in more detail.

In various aspects, the small component, with attributes such as the examples described above, may be blended with a large component consisting of particles with larger size distribution as will be described in more detail. An example of a large component surface area may be in the range of 0.1-4 m²/g. This number range is smaller than the surface area of the untreated small component particles, reflecting the fact that the surface area increases with reduced size.

According to various aspects related to calcium carbonate cement products, particles having two different size distributions may be mixed to improve packing, whereby the smaller sized particles form a matrix for the larger particles to be placed and positioned, and may fill in the gaps between larger sized particles and thereby improve the packing ratios.

In various aspects, accordingly, this displacement problem is addressed by properly engineering particle size distributions of the small and large components and their overlap, whereby the particle surface areas and distribution overlaps are engineered to reduce the effect of smaller, higher surface area ratio particles, displacing larger lower surface area ratio particles.

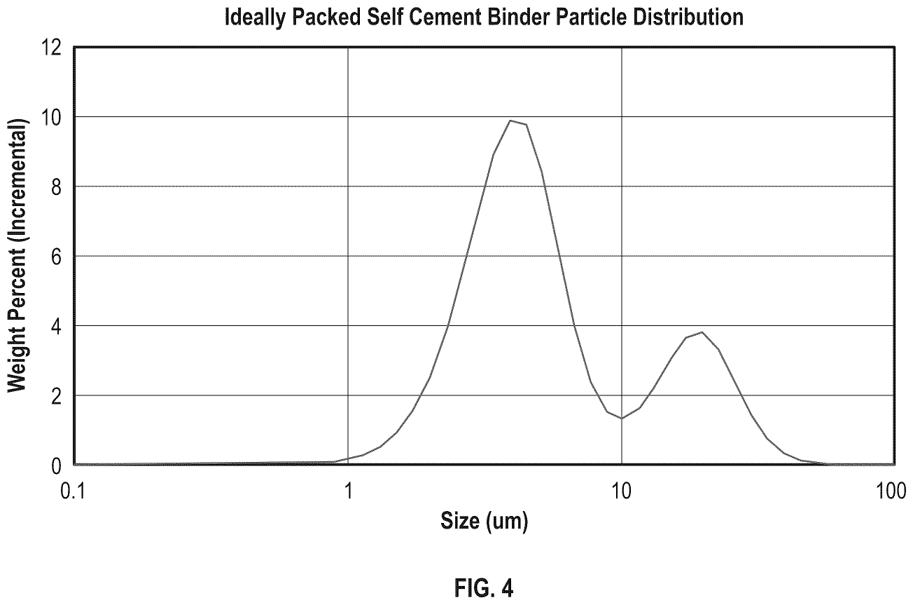

FIG. 4 is an illustration of exemplary engineered size distribution of a calcium carbonate cement blend of small and large components according to various aspects. The horizontal axis represents the size of the particles, and the vertical axis represents the percentage of the weight. As seen in this figure, there are two distinct peaks with two different most probable values, one at around 3 microns, and one at around 16 microns. In various aspects, the small component contains calcium carbonate particles having an average size in the range of 1-11 microns, while the large component contains calcium carbonate particles having an average size in the range of 10-25 or 10-35 microns.

In various aspects, the two peaks are distinguishable and well separated. In some aspects, there is less than 30% overlap between the two peaks. In some aspects, the overlap is less than 10%. The percentage of overlap represents particles which could be associated with either of the two distributions. In some aspects, the overlap may be as small as 20%, or 10% or smaller.

On the contrary, the size distribution of particles in ordinary Portland cement has no separate peaks in this distribution but a steadily growing weight as a function of size.

According to various aspects, blending multiple calcium carbonate particles, with distributions that have low overlap, yields a cementitious calcium carbonate product with minimal water demand. In these aspects, by lowering the water demand of the calcium carbonate product, the resulting calcium carbonate cement products have reduced porosity and increased compressive strength.

Accordingly, if the overlap between the two particle sizes is too great, blending different sized and surface area particles may result in increased water demand in calcium carbonate cement which is undesirable calcium carbonate cement blends of particles with increased water demand, will either have worse flows at the same total water addition, or will have higher porosity with increased water levels to achieve the same flow. This may result in a cementitious product with lower compressive strength. Accordingly, in the present aspects, particle sizes are engineered such that the size distributions of two groups of particles have minimal overlap.

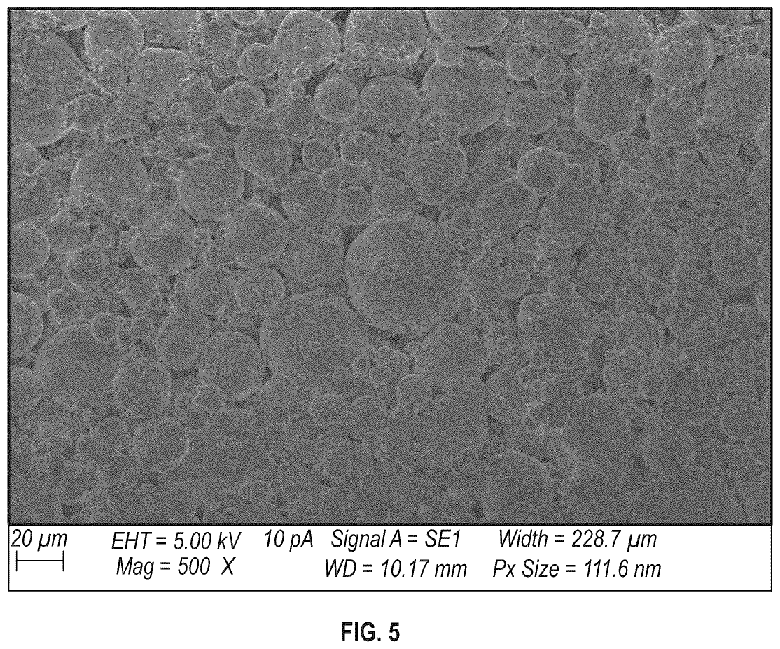

FIG. 5 is an illustration of a blend of the large and small components according to various aspects. The small component particles, as seen in the figure, form a matrix for the large component particles to be positioned. This happens without the large component particles being displaced. Accordingly, these aspects provide a tightly packed cementitious product with low water demand and high compressive strength.

For instance, in various aspects, smaller particles with higher surface area ratio, having a size distribution whereby more than 80% of the particles having a size range of 1-10 microns, are blended with larger particles with lower surface area ratio, having a size distribution whereby more than 80% particles having a size range of 6-35 microns. In some aspects, the smaller particles have a distribution peak in the range of 1-11 or 2-5 microns and the larger particles have a distribution peak in the range of 15-21 or 10-25 microns.

These engineered size distributions, according to the present aspects, result in a mixture that has an overall reduced water demand and hence, lower porosity and higher compressive strength.

These aspects achieve a high particle packing by relying on minimal overlap of discrete particle size distributions rather than focusing on blends that result in a wider particle size distribution and ignore surface area considerations. In some aspects, the size overlap may be set to a predetermined value such as 30% or 20%.

Another advantage of these aspects is that they decrease the viscosity and increase the flowability of the calcium carbonate cement product. Accordingly, fewer expensive flow enhancing additives need to be added to the blend. As a result, these aspects make for better and more cost-effectiveness of calcium carbonate cement.

In various aspects, different additives may be added to the cementitious blend to reduce the overall cost of or enhance certain properties. Additives may include sand, soil, rocks, and other aggregates to increase the overall volume of a concrete products made according to some aspects. In some aspects, other additives such as fiber may be added to the blend to enhance flexural strength of the product.

In various aspects, fillers may be added to the cementitious blend to improve its properties and/or reduce the amount of cement needed. Fillers may be fine particulates such as silica fume, fumed silica, etc. that may be chemically inert or almost inert or may provide enhanced reactivity. Fillers may also be larger particles meant to enhance overall particle distributions to improve product performance. Fillers may be produced by grinding with or without surface treatment or by other means.

Various industrial implementation schemes and procedures of calcium carbonate cement products according to the present aspects are given in the following and the accompanying figures.

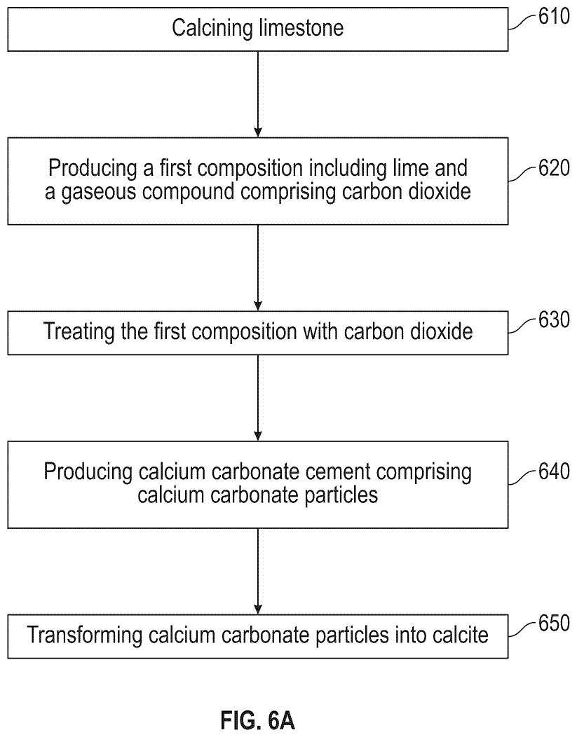

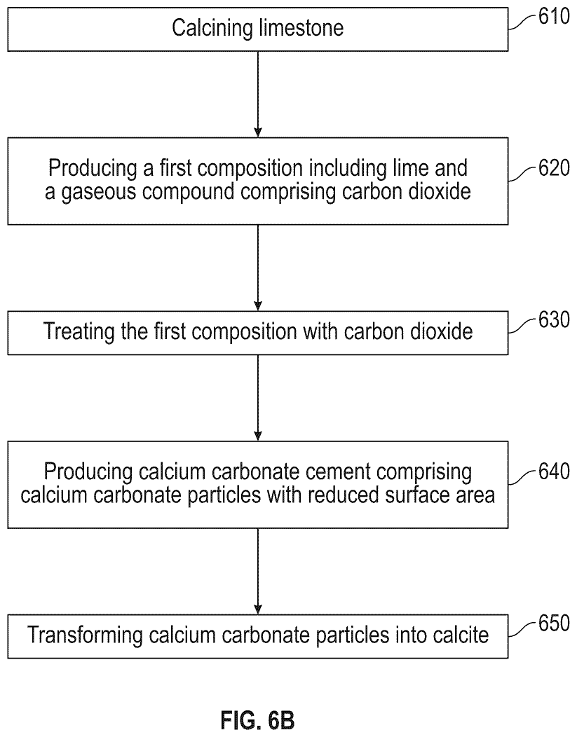

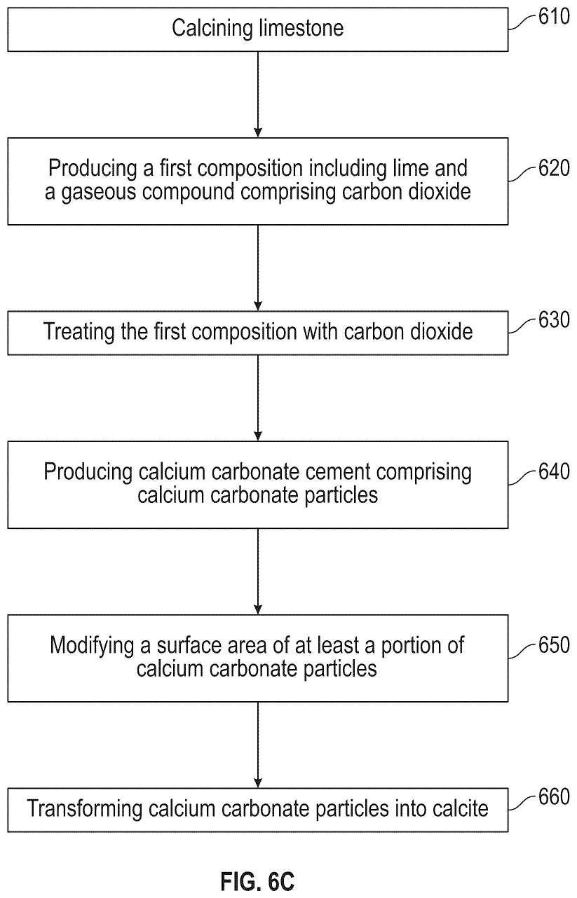

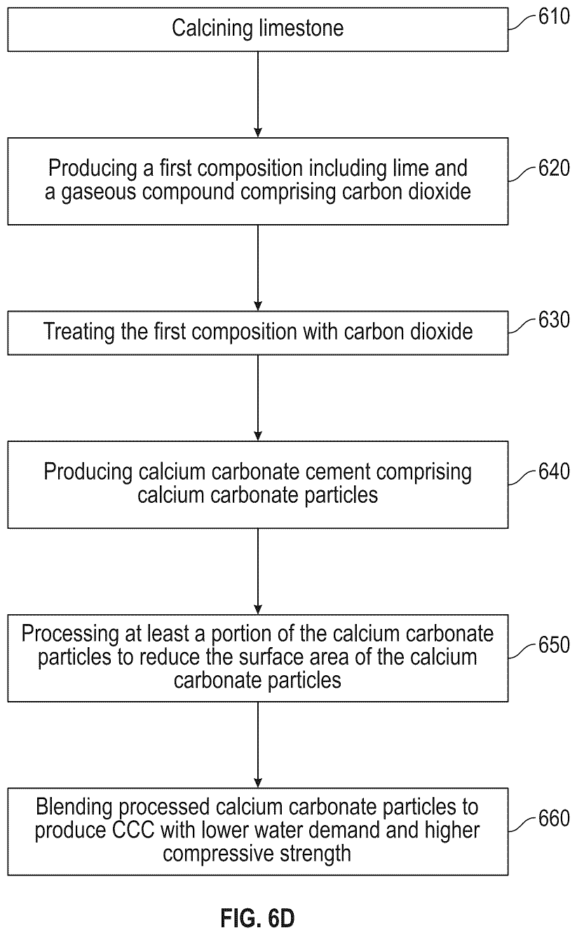

FIG. 6 is an illustration of a process to produce a cementitious blend using heat treatment on a component of particles according to various aspects.

At step 610, limestone is calcined in a kiln whereby at step 620 there is produced a first composition containing lime and a gaseous compound containing carbon dioxide. The calcination of limestone may occur in a kiln whereby limestone is heated to a decomposition temperature, thereby producing lime and a gaseous composition containing carbon dioxide. Alternatively in some aspects, a solvent such as a nitrogen-containing salt may be used to produce calcium carbonate cement at a lower temperature.

At step 630, the first composition containing lime is treated with the gaseous compound containing carbon dioxide to produce calcium carbonate cement containing calcium carbonate particles at step 640. This process is environmentally advantageous as it prevents the released carbon dioxide from being emitted into the atmosphere and instead, it reabsorbs the carbon dioxide thereby forming the calcium carbonate cement.

At step 650, at least a portion of the calcium carbonate particles are processed to engineer the size and the surface area of the calcium carbonate particles.

At step 660, engineered calcium carbonate particles are blended to produce calcium carbonate cement with lower water demand and higher compressive strength. At step 670, water is added to the product and the vaterite portion of the calcium carbonate cement transforms to calcite, forming a strong cementitious product.

In some aspects, in addition to water, the process may further include adding any of calcium salts, flow aids, plasticizers, organic compounds, and acidic buffer to the composition. The calcium salt may be any suitable calcium salt such as calcium chloride, calcium nitrate, or calcium sulfate. In some aspects, flow enhancement material may be used.

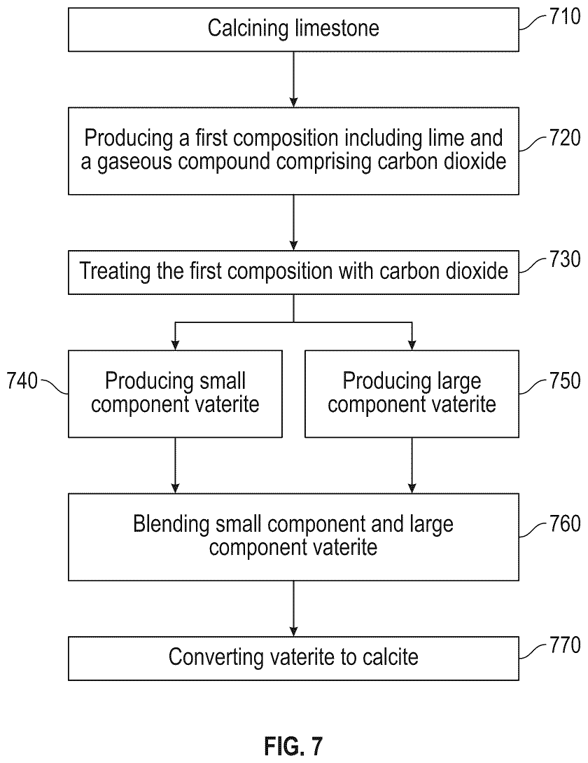

FIG. 7 is an illustration of a process to produce a cementitious blend using different size particle distribution and heat treatment according to various aspects.

At step 710, limestone is calcined in a kiln whereby at step 720 there is produced a first composition containing lime and a gaseous compound containing carbon dioxide.

At step 730, the first composition containing lime is treated with the gaseous compound containing carbon dioxide to produce calcium carbonate cement containing calcium carbonate particles. This process is environmentally advantageous as it prevents the carbon dioxide from being emitted into the atmosphere and instead, it reabsorbs the carbon dioxide.

The process of step 730 may be engineered to produce small component and large component calcium carbonate cement particles. At step 740, small component calcium carbonate particles are produced. At step 750, large component calcium carbonate particles are produced. These two latter steps may be performed in the order suitable so long as the two different small component and large component are produced.

At step 760 calcium carbonate particles of the small component and large component are blended to produce calcium carbonate cement with lower water demand and higher compressive strength.

At step 770, the calcium carbonate composition, which may consist of mostly vaterite and some aragonite, is treated to transform these polymorphs to calcite cement.

In various aspects, transforming vaterite to calcite may be facilitated by adding water to the composition. In some aspects, at step 770, in addition to water, other additives may be added to the product to facilitate the transformation of vaterite to calcite. In some aspects, an acidic solution may be added. In some aspects, a weak acid or a conjugate base may be added. In some aspects an acidic buffer is made by adding a weak acid and its conjugate base. An exemplary compound may be chosen to be a carboxylic acid or derivative such as citric acid, acetic acid, and sodium acetate. In some aspects, calcite seeds are added to the composition to facilitate the transformation of vaterite to calcite.

In some aspects, pH values for the additives are between 1 and 7. In some aspects molarities of the solution are from 0 to 1 M. In some aspects, when the solution is added to the calcium carbonate cement, a portion of the CaCO₃ will dissolve to neutralize the pH of the solution to a pH ranging from 6 to 8.

In some aspects the pH values may be modified to prevent corrosion to protect steel rebars once the product is used in concrete.

In some aspects, an air entrainer may be added to the cementitious blend. Air entraining admixtures chemicals surfactants that consist of a water-repelling chain (nonpolar hydrocarbon) with a water-attractive chain (anionic polar).

There are several beneficial effects the organic compound additives may have in these aspects. First, by partially dissolving the CaCO₃ the flow can increase, and the viscosity of the composition may decrease, thereby allowing for improved workability.

Additionally, by altering the chemical state of the solution, the kinetics of the reactivity can be changed to tune how fast the reaction happens for different applications.

In some aspects, by dissolving and reprecipitating CaCO₃, the organic compound additives may turn traditionally inert forms of CaCO₃ (like calcite/limestone) into reactive CaCO₃. This may be caused by dissolving parts of the more inert CaCO₃ with the acidic pH. As the pH is returned to a more neutral pH in the region of 7-8, the dissolved Ca²⁺ and CO³⁻ can reprecipitate between the inert particles, locking them into place and facilitate creating the cementitious product.

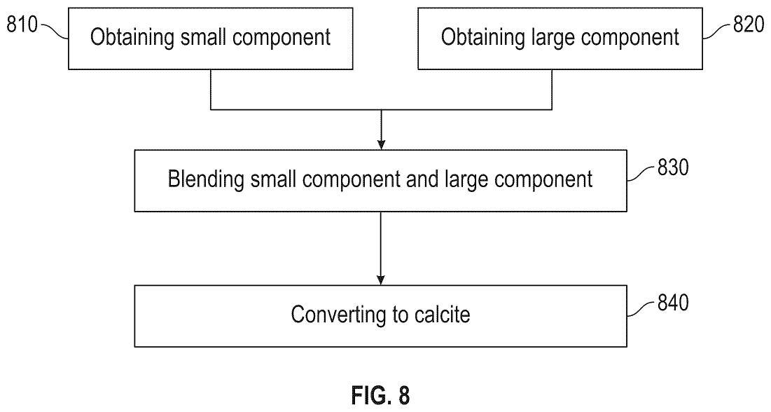

FIG. 8 is an illustration of a process to blend different size distribution particles according to various aspects. At step 810, a sample of calcium carbonate particles of smaller size is obtained. This sample is referred to as small component calcium carbonate. At step 820, a sample of calcium carbonate particles of larger size is obtained. This sample is referred to as large component calcium carbonate. The order of steps 810 and 820 may be set in any suitable manner.

At step 830, small and large component calcium carbonate are blended. The blending may occur in any suitable manner with either of the two components being added to the other, or simultaneous blending in a new container or reactor.

At step 840, the blended composition is transformed to calcite. Before the transformation, the blend may consist of any ratio of multiple polymorphs such as vaterite, aragonite, and calcite. Different ways of facilitating a transformation were explained above.

In various aspects, once both the small component and the large component particles are prepared, they are blended together as discussed above to form a tightly packed cementitious blend with low water demand and high compressive strength. Meanwhile, the process of these aspects is greatly environmentally advantageous as it prevents the carbon dioxide emissions of traditional cement factories by reabsorbing the carbon dioxide, produced during calcination of limestone, back into the cement.

According to various aspects, heating calcium carbonate, and in particular vaterite, in the range of 300 to 600° C. or up to 700° C. is utilized to reduce the surface area of small component vaterite particles. This process may be attributed to a solid-state transformation whereby calcium carbonate atoms undergo a crystallographic rearrangement to a lower energy state. The reduced surface area according to these aspects provides for lower water demand of the cementitious blend.

Without the engineering explained above, for a given particle size, as the surface area of calcium carbonate particles increases, their water demand increases. This not only means higher surface area particles may have higher viscosities, but when additional water is added to the calcium carbonate to achieve improved flowability the system will have increased porosity. This increased porosity can lead to reduced strength and potentially an inferior product.

In various aspects, limestone may be calcined to decompose it to lime and carbon dioxide. The calcination of limestone may occur in a kiln whereby limestone is heated to a decomposition temperature, thereby producing lime and a gaseous composition containing carbon dioxide.

Alternatively, a solvent such as a nitrogen-containing salt may be used to produce calcium carbonate cement at a lower temperature. Once vaterite is produced, a portion of it may be treated to reduce the surface area ratio.

By heating vaterite at temperatures from 300 to 600° C. the surface area can be substantially reduced. This leads to lower viscosities (both as a powder and in a liquid mixture) as well as reduced porosities and increased strength for cementitious applications.

In some aspects, the small component may partially consist of vaterite with a median size in a range of 1-6 or 2-5 microns synthesized to have a low surface area by manipulating concentrations of calcium oxide and ammonium chloride, and the pH and temperature of the reactor. This reduced surface area vaterite assists in reducing the water demand of the cementitious system. In some aspects, this low surface area vaterite or a portion of it may be heated in the range of 200 to 700° C. to convert it to low surface area calcite.

By decreasing viscosity and increasing the flowability of calcium carbonate products, fewer expensive flow enhancing additives need to be used. As a result, the present aspects may increase the cost competitiveness of calcium carbonate cements. Additionally, by reducing porosity and increasing strengths, this method may unlock new, higher value applications to calcium carbonate materials.

When calcium carbonate materials are exposed to heat in the region of 300 to 600° C. degrees, crystallographic rearrangements occur that act to smoothen the surface and reduce pore sizes and frequencies. This results in smoother particles that have reduced water demand. This rearrangement can happen without phase transformations (ie vaterite heated and remaining vaterite) or with phase transformations (ie vaterite heated and transforming to calcite). In either case, surface areas can be reduced substantially (70% or more). With the same particle size distribution, smoother particles with lower surface areas require less water to achieve equivalent viscosities. As such this process reduces the need to use expensive flow enhancing additives to achieve needed flowability while ensuring minimal water is added that would result in increased porosity and decreased strength of the resulting cementitious material.

In various aspects, the addition of strontium containing compounds (such as SrCl₂, Sr(NO₃)₂, etc.) to vaterite in the range of 0 to 2 wt % may increase the resulting strength after transformation to calcite.

When exposed to water, vaterite is able to transform to calcite. This transformation acts to cement particles together, resulting in a rigid product that can support external forces. The addition of strontium containing compounds to the vaterite (either added to/within the vaterite during the manufacturing process, or as a soluble additive to the water during the final mixing process) results in a change to the calcite crystal formation process that results in a modified network of calcite particles that can withstand greater external forces before failure.

In various aspects a cementitious blend is provided by blending large component vaterite particles with a small component comprising ground limestone.

In various aspects, a device is utilized to grind limestone. Any suitable device maybe used such as, without limitation, a ball mill, a rod mill, an autogenous mill, a semi-autogenous grinding (“SAG”) mill, a pebble mill, a high-pressure grinding roll, a buhrstone mill, a vertical shaft impactor mill (VSI mill), a tower mill, and a vibratory mill.

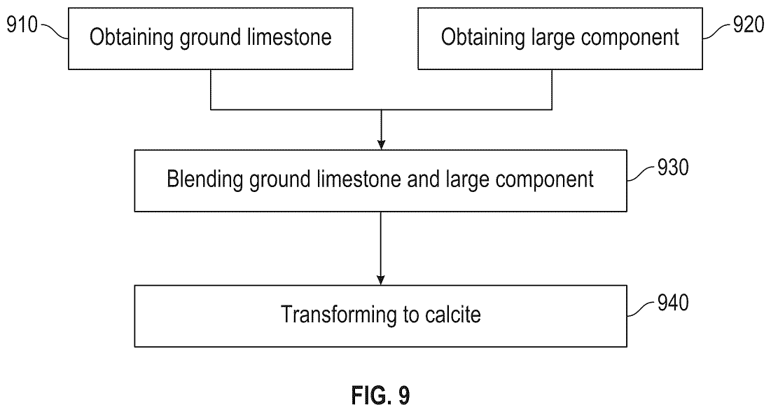

FIG. 9 is an illustration of a process to blend ground limestone with calcium carbonate particles according to various aspects. At step 910, a sample of ground limestone particles of smaller size is obtained. At step 820, a sample of calcium carbonate particles of larger size is obtained. This sample is referred to as large component calcium carbonate. The order of steps 910 and 920 may be set in any suitable manner.

At step 930, ground limestone and large component calcium carbonate are blended. The blending may occur in any suitable manner with either of the two components being added to the other, or simultaneous blending in a new container or reactor.

At step 890, the blended composition is transformed to calcite. Before the transformation, the blend may consist of a combination of multiple polymorphs such as vaterite, aragonite, and calcite. Different ways of facilitating a transformation were explained above.

In some aspects, the griding of limestone is engineered to achieve particles of 1-10 microns. These particles, when blended with the large component particles described above, help achieve a blend with tight packing according to the same process described above. Resulting in better packing and reduction of porosity and water.

In various aspects, the ground limestone may acquire a median size of 1-10 microns. In some aspects, the distribution of the limestone particles, especially for smaller median sizes, may be skewed with a mean value greater than the median, and a median value greater than the mode.

In some aspects where the ground limestone particles have a median size of 2 microns, the distribution is bounded by 1 micron at the 10% percentile to 5 microns at the 90% percentile.

In some aspects where the ground limestone particles have a median size of 10 microns, the distribution is bounded by 4 microns at the 10% percentile to 20 microns at the 90% percentile.

In various aspects, the addition of smaller component ground limestone as described above is utilized as a seed and a matrix for the placement and positioning of large component dissolved vaterite, whereby the vaterite particles reprecipitate onto the small component ground limestone particles and start to transform into calcite. The small component ground limestone particles thereby provide a scaffold for the large component vaterite particles and thereby are enabled to reprecipitate onto such supplied scaffold much faster than without.

Various aspects using ground limestone as the small component demonstrate a compressive strength exceeding 5,000 psi following the standard ASTM mortar test (ASTM C109).

One advantage of the present aspects, using ground limestone as the small component, is the fact that they may not require a lot of filtering and cleaning. Accordingly, such products made in accordance with such aspects may be manufactured with less pure materials and there will be less need to clean out impurities by filtering off insoluble impurities.

Another advantage of the present aspects, using ground limestone as small component, is lowering product cost due to relative inexpensiveness of limestone. In addition, the grinding process may be designed around particular use cases. For instance, finely ground limestone may be used for applications requiring higher compressive strength or texture smoothness, whereas more coarsely ground limestone may be used for applications which do not require a lot of compressive strength or texture smoothness.

Another advantage of the present aspect is that using ground limestone as a component of the cement causes lower carbon dioxide emission. Ordinary Portland cement is typically produced by heating limestone to a temperature of 1450 degrees centigrade in a process which decomposes the limestone into lime and carbon dioxide which is traditionally released into the atmosphere. Using limestone with no calcination lowers the carbon dioxide emission by eliminating both the heating process and the decomposition.

Another advantage of the present aspect is that using ground limestone as a component of the cement may lower capital or operation expenditure as limestone is abundantly found in nature and the process of these aspects is done without chemical material processing.

Another advantage of the present aspect is that instead of blending calcite in post synthesis, lower purity, potentially ‘off spec’ materials may be sent through the reactor, reducing the need for high purity kiln processes.

Using ground limestone according to the present aspects may further drive down the porosity of the cementitious material as otherwise vaterite may have high porosity and when heated and transformed into calcite it may still retain high porosity. Ground limestone, however, does not have high porosity and may reduce water demand and increase the compressive strength of the final cementitious product.

In various aspects, the small component comprises both calcium carbonate cementitious particles and ground limestone particles. These two different constituents make up the small component together. Some of the benefits of having ground limestone in the composition were discussed above.

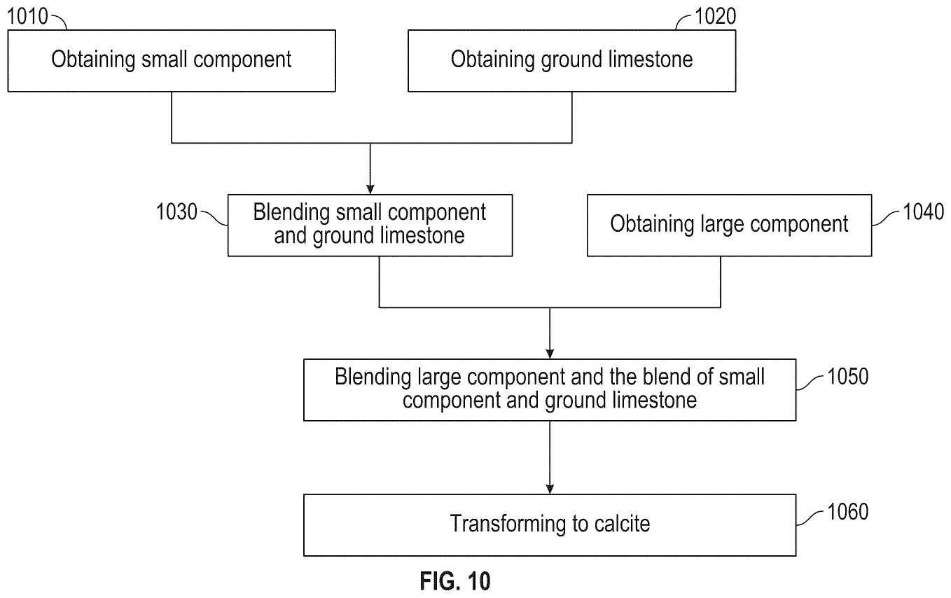

FIG. 10 is an illustration of producing a cement product containing ground limestone and different calcium carbonate particle size components according to various aspects. At step 1010, a sample of calcium carbonate particles of smaller size is obtained. This sample is referred to as small component calcium carbonate.

At step 1020, a sample of ground limestone is obtained. This sample is referred to as large component calcium carbonate. The order of steps 1010 and 1020 may be set in any suitable manner.

At step 1030, the small component and the ground limestone are blended. The blending may be done in any order suitable including adding one onto the other or mixing the small component and the ground limestone in a third container or reactor.

At step 1040, a sample of calcium carbonate particles of larger size is obtained. This sample is referred to as large component calcium carbonate. The order of steps 1030 and 1040 may be set in any suitable manner.

At step 1050, blend of the small component and ground limestone is blended with the large component. The blending may occur in any suitable manner with either of the two components being added to the other, or simultaneous blending in a new container or reactor.

At step 1060, the blended composition is transformed to calcite. Before the transformation, the blend may consist of any ratio of multiple polymorphs such as vaterite, aragonite, and calcite. Different ways of facilitating a transformation were explained above.

One benefit of adding ground limestone instead of, or in addition to, heat treated vaterite according to these aspects is that the resulting calcium carbonate cement may reduce thixotropy and behave much more like a Newtonian fluid.

In various aspects, the ground limestone was found to act as an accelerant and enhance the vaterite to calcite transformation, thereby improving the cementitious product performance in terms of reaction time & strength.

In some aspects, when an acidic buffer or an acid is used, a very small portion of the ground limestone may be activated turning it into a cementitious material.

In various aspects, a blend of vaterite and ground limestone is used as the small component while the large component consists of larger vaterite particles. The combination of vaterite and ground limestone provides a matrix for larger vaterite particles to bind to while facilitating the transformation of both the small and large component vaterite particles into calcite.

In these aspects, the specific of the ratio and size of the small component blend are engineered for optimal packing. The specific size of the ground limestone and the relative size of the vaterite particles may be tuned for optimal packing, resulting in better compressive strength.

In these aspects, the small component blend of vaterite and ground limestone, may be manipulated according to specific applications. For instance, for higher compressive strength and to enhance the flow, a higher ratio of vaterite particles may be used in the small component blend. On the other hand, for lower cost or faster set time, a higher ratio of ground limestone may be used in the small component blend. In addition, the grinding process of the limestone may be tuned for desirable performance of the final cementitious product.

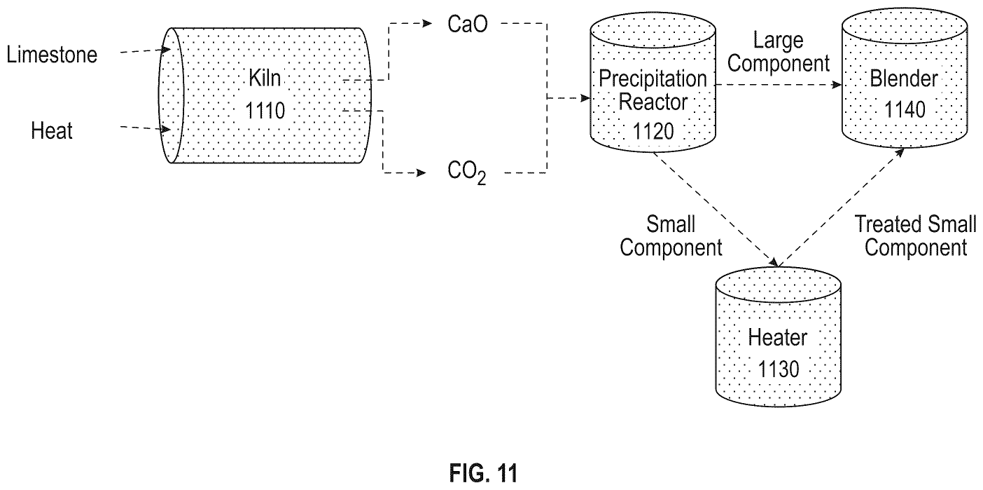

FIG. 11 is an illustration of industrial implementation example of various aspects using a common precipitation reactor. In these aspects, lime and heat and input into kiln 1110 where the heat causes the decomposition of the limestone, thereby producing a composition containing lime and a gaseous compound containing carbon dioxide.

Lime and the carbon dioxide are input into precipitation reactor 1120, where the carbon dioxide reabsorbed producing precipitated calcium carbonate cement, in the form of vaterite, aragonite, or calcite. In some aspects, the precipitated calcium carbonate is mostly vaterite, with possible small components of aragonite and calcite present.

Precipitation reactor 1120 may produce small and large component calcium carbonate cement particles by engineering certain parameters. In some aspects, different sizes of calcium carbonate cement particles can be controlled by changing the residence time, the speed at which different solutions are introduced into and extracted from the reactor, and mixing speed in the reactor and by changing the purity levels, which is related to the amount of insoluble minerals, of the feed solution coming into the reactor.

Small component calcium carbonate cement may be obtained by heater 1130 where it goes through heat treatment to reduce the surface area ratio of the particles. This is crucial for producing a tightly packed calcium carbonate cement product as discussed above. Small component calcium carbonate cement particles provide a matrix for the large component calcium carbonate cement particles to be placed, positioned, and bind to.

In some aspects, heater 1130 operates at a temperature range of 300-600° C. (Celsius). In some aspects, heater 1130 operates at a temperature range of up to 700° C. In some aspects heater 1130 operates at a temperature close to 650° C. In some aspects heater 1130 operates at a temperature close to 150° C.

In the process of heat-treating the small component calcium carbonate cement in heater 1130, at least a portion of the calcium carbonate cement particles may transform to calcite. Calcite is the most stable of the three polymorphs, the other two being vaterite and aragonite. The calcium carbonate cement particles, prior to heat-treating may consist of mostly vaterite.

After heat treatment, the heat-treated small component calcium carbonate cement is transferred from heater 1130 to blender 1140 which may be any suitable blending module. The large component calcium carbonate cement is transferred directly from precipitation reactor 1120 to blender 1140. The two components are then blended in blender 1140, where a tightly packed cementitious blend is thereby produced.

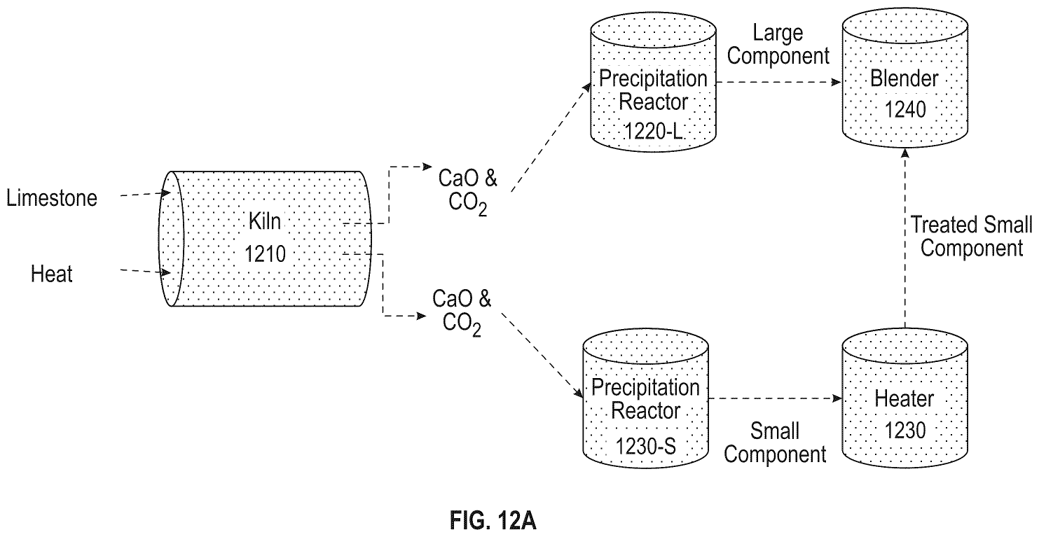

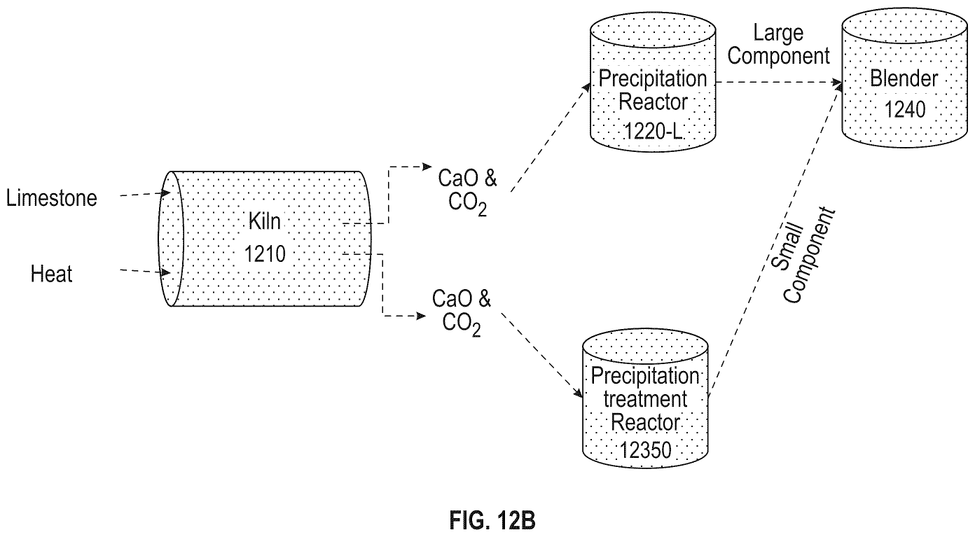

FIG. 12 is an illustration of industrial implementation example of various aspects using a different precipitation reactor. In these aspects, lime and heat and input into kiln 1210 where the heat causes the decomposition of the limestone, thereby producing a composition containing lime and a gaseous compound containing carbon dioxide.

The lime and the carbon dioxide are partially input into precipitation reactor 1220-L where large component calcium carbonate cement is produced. Another portion of the lime and the carbon dioxide are input into precipitation reactor 1220-S where small component calcium carbonate cement is produced.

Small component calcium carbonate cement may be obtained by heater 1230 where it goes through heat treatment to reduce the surface area ratio of the particles whereby during the process of heat-treating the small component calcium carbonate cement in heater 1230, at least a portion of the calcium carbonate cement particles may transform to calcite as described above.

After heat treatment, the heat-treated small component calcium carbonate cement is transferred from heater 1230 to blender 1240. The large component calcium carbonate cement is transferred directly from precipitation reactor 1220-L to blender 1240. The two components are then blended in blender 1240, where a tightly packed cementitious blend is thereby produced.

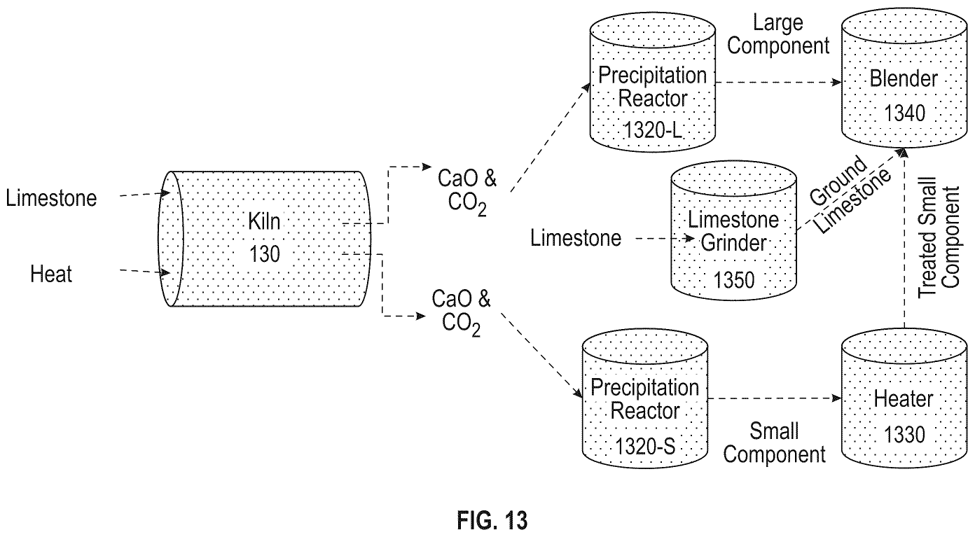

FIG. 13 is an illustration of industrial implementation example of various aspects using ground limestone. In these aspects, lime and heat are input into kiln 1310 where the heat causes the decomposition of the limestone, thereby producing a composition containing lime and a gaseous compound containing carbon dioxide.

Lime and the carbon dioxide are partially input into precipitation reactor 1320-L where large component calcium carbonate cement is produced. Another portion of the lime and the carbon dioxide are input into precipitation reactor 1320-S where small component calcium carbonate cement is produced.

Small component calcium carbonate cement may be obtained by heater 1330 where it goes through heat treatment to reduce the surface area ratio of the particles whereby during the process of heat-treating the small component calcium carbonate cement in heater 1330, at least a portion of the calcium carbonate cement particles may transform to calcite as described above.

In various aspects, in addition to the large component and the small component calcium carbonate cement particles, the composition may include ground limestone. Limestone is obtained by limestone grinder 1350 where it is ground into a desirable size as described above. The three components of large component calcium carbonate cement, heat-treated small component cement, and ground limestone are then blended in blender 1340 to produce a tightly packed cementitious blend.

In various aspects, the ratio of small component calcium carbonate cement and ground limestone may be adjusted according to various desired characteristics of the final cementitious blend as well as cost considerations of the final product. In some aspects, in particular, ground limestone may completely replace the small component. In such aspects, the ground limestone particles provide a matrix for the large component calcium carbonate cement products to be positioned, thereby producing a tightly packed cementitious blend.

According to various aspects, in any of the aspects of FIGS. 11, 12, and 13, there may be an additional step for transforming different calcium carbonate cement polymorph into calcite as described above.

In various aspects a method to produce calcium carbonate cement starts with obtaining sample of calcium carbonate particles having a size distribution. The size distribution may be a specific size distribution which upon altering the size distribution, one may achieve a better workability or a lower water demand or a combination of both.

In some aspects, altering the size distribution may be achieved by using a mill to broaden the size distribution. Any suitable milling device may be used to alter the size distribution. In some aspects, altering the size distribution may constitute smoothing out the surface area of the calcium carbonate particles.

In some aspects, a fine component may be added to the calcium carbonate particles to affect the setting time of the calcium carbonate cement.

In some aspects, one may alter the calcium carbonate particle size distribution to lower the paste viscosity or to reduce shear stiffening.

Although the foregoing aspects have been described in some detail by way of illustration and example for purposes of clarity of understanding, it should be readily apparent to those of ordinary skill in the art in light of the teachings of these aspects that certain changes and modifications may be made thereto without departing from the spirit or scope of the appended claims. Accordingly, the preceding merely illustrates the principles of the present aspects.

It will be appreciated that those skilled in the art will be able to devise various arrangements, which, although not explicitly described or shown herein, embody the principles of the present aspects, and are included within its spirit and scope. Furthermore, all examples and conditional language recited herein are principally intended to aid the reader in understanding the principles of the present aspects and the concepts contributed by the inventors to furthering the art, and are to be construed as being without limitation to such specifically recited examples and conditions.

Moreover, all statements herein reciting principles, aspects, and the present aspects as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

The scope of the present aspects, therefore, is not intended to be limited to the examples shown and described herein. It is intended that the following claims define the scope of the present aspects and that processes and structures within the scope of these claims and their equivalents be covered thereby.

1- A cementitious blend comprising:
a small component comprising calcium carbonate particles having a smaller size distribution; and,
a large component comprising calcium carbonate particles having a larger size distribution;
wherein the smaller size distribution and the larger size distribution have an overlap of less than a specific ratio of a total weight of the cementitious blend.

2- The cementitious blend of claim 1, wherein the specific ratio is 30%.

3- The cementitious blend of claim 1, wherein the small component comprises calcium carbonate particles with a median size in a range of 1-11 microns.

4- The cementitious blend of claim 1, wherein the large component comprises calcium carbonate particles with a median size in a range of 10-35 microns.

5- The cementitious blend of claim 1, wherein the cementitious blend is transformed to at least one of calcite and aragonite.

6- The cementitious blend of claim 1, further comprising calcite seeds to effect a transformation of calcium carbonate particles to calcite.

7- The cementitious blend of claim 1, wherein the small component comprises 50% or less by weight of the cementitious blend.

8- The cementitious blend of claim 1, wherein the small component is treated to reduce a surface area of calcium carbonate particles.

9- The cementitious blend of claim 8, wherein the small component is treated by heating the small component to a temperature in a range of 150-700 degrees Celsius.

10- A cementitious blend comprising a plurality of components each comprising calcium carbonate particles having different sizes, wherein a size overlap of at least two of the plurality of components is less than a specific ratio of a total weight of the cementitious blend.

11- The cementitious blend of claim 10, wherein the specific ratio is 30%.

12- The cementitious blend of claim 10, wherein the cementitious blend comprises a smaller component having calcium carbonate particles with an average size in a range of 1-11 microns.

13- The cementitious blend of claim 10, wherein the cementitious blend comprises a larger component having calcium carbonate particles with an average size in a range of 10-35 microns.

14- The cementitious blend of claim 10, wherein at least one component having calcium carbonate particles of a smaller size is treated to reduce a surface area of the calcium carbonate particles in the at least one component.

15- The cementitious blend of claim 14, wherein the at least one component is treated by heating the at least one component to a temperature in a range of 150-700 degrees Celsius.

16- The cementitious blend of claim 10, wherein the cementitious blend further comprises ground limestone.

17- A system for producing a cementitious composition, the system comprising:
at least one reactor configured to produce a first component comprising calcium carbonate particles of larger size;
at least one reactor configured to produce a second component comprising calcium carbonate particles of smaller size;
a blending module configured to blend the first component and the second component to produce a tightly packed blend; and,
at least one reactor configured to effect a transformation of the tightly packed blend to produce calcite cement.

18- The system of claim 17, wherein a size distribution of the first component and a size distribution of the second component have an overlap that is less than a specific ratio.

19- The system of claim 18, wherein the specific ratio is 30%.

20- The system of claims 17, wherein the first component and the second component are produced in a common reactor.
